(19) United States
(12) Patent Application Publication
(10) Pub. No.: US 2026/0097796 A1
(43) Pub. Date: Apr. 9, 2026

(54) METHODS AND SYSTEMS FOR RAILCAR CONTENT ANALYSIS AND ALLOCATION MANAGEMENT

(71) Applicant: CSX Transportation, Inc., Jacksonville, FL (US)

(72) Inventors: Elvis Higgins, Jacksonville, FL (US); Bharat Sharma, Jacksonville, FL (US)

(21) Appl. No.: 18/910,602

(22) Filed: Oct. 9, 2024

(51) Int. Cl. B61L 17/00; B61L 27/30; B61L 27/70; G06T 7/00

(52) U.S. Cl. CPC B61L 17/00; B61L 27/30; B61L 27/70; G06T 7/0004; G06T 2207/30248

(57) ABSTRACT

A computer-implemented method for allocating railcars in a rail yard based upon analysis of contents of the railcars is disclosed. The method includes generating, via a LiDAR sensor, images of the railcars. A network interface sends the images of the railcars to an analysis unit. The analysis unit analyzes the images of the railcars. Based on the analysis, the analysis unit determines a contents status for each of the railcars. A notification module transmits notifications to at least one of the mobile computing devices, where each of the notifications include at least one of: railcar contents statuses or images of the railcars. In response to the transmitting of the at least one notification, the railcars are sorted to different locations via at least one of the plurality of rail yard workers, where each of the different locations are based on a railcar contents status.

### BACKGROUND

A rail yard encompasses a network of tracks that is utilized to load, unload, sort, and/or store locomotives and rail vehicles. Depending on the size of a rail yard, a rail yard can host between a couple dozen locomotives/rail vehicles and a couple thousand locomotives/rail vehicles daily. Generally, many, if not all, of the rail vehicles are railcars that are used to transport various types of goods from one location to another. Shipped goods can include small items, such as shoes and clothing, and can include larger items, such as automobiles. In order to provide effective unloading, the railcars may be grouped within the railyard based on the goods they are carrying. For larger items (such as automobiles), the unloading process can be very cumbersome.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is an illustration of an exemplary environment including components associated with managing and analyzing railcars and their contents, in accordance with certain embodiments of the present disclosure;

FIG. 2 is an illustration of a computing machine and a system applications module, in accordance with certain example embodiments;

FIG. 3A is an illustration of a LiDAR sensor capturing images of railcars in a rail yard, in accordance with certain embodiments of the present disclosure;

FIG. 3B is an illustration of an exemplary LiDAR image taken of a railcar in a rail yard, in accordance with certain embodiments of the present disclosure;

FIG. 4 is a diagrammatic view of an operator mobile computing device for managing information relative to an autorack facility in accordance with certain embodiments of the present disclosure; and

FIG. 5, which is an illustration of an exemplary computer-implemented method for allocating a plurality of railcars in a rail yard based upon analysis of contents of the plurality of railcars, in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present invention relates generally to computerized methods and systems for managing railcars in a railyard, and more particularly to content analysis of railcars and allocation management of the railcars based on the content analysis. The term “railcar” is used herein to refer to a vehicle utilized for carrying cargo along tracks of a rail transport network. The term “locomotive” is used herein to refer to a powered rail vehicle for pulling railcars (as described above). The term “autorack” is used herein to refer to a type of railcar utilized for carrying automobiles along tracks of a rail transport network.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

Unless otherwise indicated, all numbers expressing quantities of components and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

Presented herein is a system for allocating a plurality of railcars in a rail yard based upon analysis of contents of the plurality of railcars. The system comprises a network interface configured to communicatively couple the system to a plurality of mobile computing devices for a plurality of rail yard workers. A LiDAR sensor is configured to create images of the plurality of railcars. An image database is configured to store the images of the plurality of railcars. An analysis unit is configured to analyze the images of the plurality of railcars. A notification module is configured to send at least one of: the images of the plurality of railcars or the analysis of the images of the plurality of railcars to at least one of the plurality of mobile computing devices. One or more tangible, non-transitory memories store computer-executable instructions that, when executed by one or more processors of the system, cause the system to: generate the images of the plurality of railcars, send the images of the plurality of railcars to the analysis unit, and analyze the images of the plurality of railcars. Based on the analysis, the system further determines a contents status for each railcar of the plurality of railcars and transmits at least one notification to at least one of the plurality of mobile computing devices, where each of the at least one notification includes at least one of: one or more of the railcar contents status or one or more of the images of the plurality of railcars. In response to the transmitting of the at least one notification, the plurality of railcars are sorted to at least two different locations via at least one of the plurality of rail yard workers, where each of the at least two different locations are based on a respective one of the one or more of the railcar contents status.

Presented herein is a computer-implemented method for allocating a plurality of railcars in a rail yard based upon analysis of contents of the plurality of railcars via an electronic or communications network. The method comprises generating, via a LiDAR sensor, images of the plurality of railcars. A network interface sends the images of the plurality of railcars to an analysis unit. The analysis unit analyzes the images of the plurality of railcars. Based on the analysis, the analysis unit determines a contents status for each railcar of the plurality of railcars. A notification module transmits at least one notification to at least one of the plurality of mobile computing devices, where each of the at least one notification includes at least one of: one or more of the railcar contents status or one or more of the images of the plurality of railcars. In response to the transmitting of the at least one notification, the plurality of railcars are sorted to at least two different locations via at least one of the plurality of rail yard workers, where each of the at least two different locations are based on a respective one of the one or more of the railcar contents status.

Presented herein is a non-transitory computer-readable storage medium storing one or more programs configured to be executed by one or more processors of an electronic device. The one or more programs include instructions for: generating, via a LiDAR sensor, images of the plurality of railcars; sending, via a network interface, the images of the plurality of railcars to an analysis unit; analyzing, via the analysis unit, the images of the plurality of railcars; based on the analysis, determining, via the analysis unit, a contents status for each railcar of the plurality of railcars; and transmitting, via a notification module, at least one notification to at least one of the plurality of mobile computing devices, where each of the at least one notification including at least one of: one or more of the railcar contents status or one or more of the images of the plurality of railcars. In response to the transmitting of the at least one notification, the plurality of railcars are sorted to at least two different locations via at least one of the plurality of rail yard workers, where each of the at least two different locations are based on a respective one of the one or more of the railcar contents status.

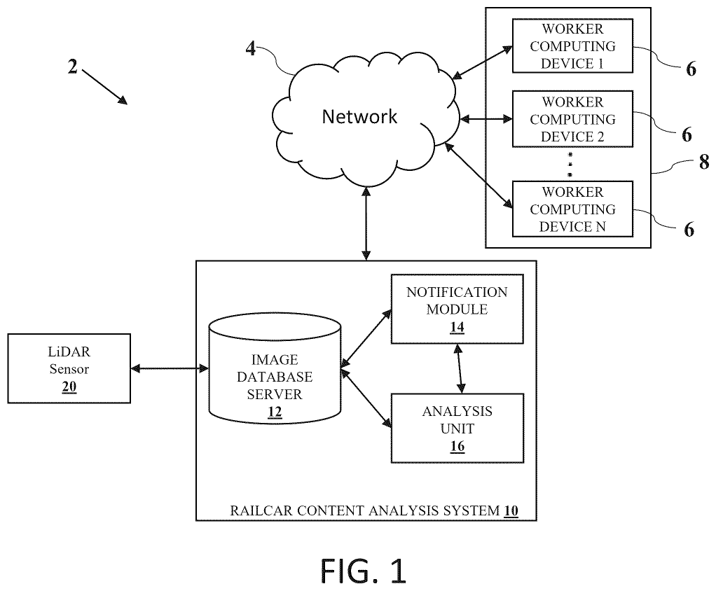

FIG. 1 is an illustration of an exemplary environment 2 including components associated with managing and analyzing railcars and their contents, in accordance with certain embodiments of the present disclosure. As shown in FIG. 1, environment 2 may include computing devices 6 associated with N respective rail yard workers of a rail yard management team 8 (e.g., three rail yard workers, ten rail yard workers, etc.). Each of the computing devices 6 may include any suitable type of computing device having wired and/or wireless communication capabilities, such as a personal computer, tablet, phablet, smartphone, etc. Each of the rail yard worker computing devices 6 may be communicatively coupled to railcar content analysis system 10 via one or more electronic or communications networks 4. The one or more electronic or communications networks 4 may be a single network, or may include multiple networks of one or more types (e.g., one or more wired and/or wireless LANs, and/or one or more wired and/or wireless WANs such as the Internet), for example. Each of the rail yard workers may be an individual associated with a rail yard management team 8 in which the rail yard workers collectively manage railcars and other vehicles/machinery in a rail yard. In one non-limiting embodiment, the railcars managed by the rail yard workers may be autoracks used to carry automobiles.

Environment 5 may further include railcar content analysis system 10, which may comprise a computing system. Railcar content analysis system 10 may include one or more servers, or may include a plurality of networked computing devices that have an appearance of a single, logical computing device or system, e.g., a peer group of computing devices, a group of cloud computing devices, or the like. Railcar content analysis system 10 may be communicatively coupled to computing devices 6 via one or more electronic or communications networks 4. The one or more electronic or communications networks 4 may be a single network, or may include multiple networks of one or more types (e.g., one or more wireless and/or wired local area networks (LANs), and/or one or more wireless and/or wired wide area networks (WANs) such as the Internet), for example.

Railcar content analysis system 10 may include various components, including an image database server 12, a notification module 14, and/or an analysis unit 16. Each of some or all of the components 12, 14, and 16 may be (or may include) a respective set of one or more computing devices or processors that executes software or computer-executable instructions to perform the corresponding functions described herein. Alternatively, each of some or all of the components 12, 14, and 16 may be, or include, a respective component of software or set of computer-executable instructions that is stored on one or more tangible, non-transitory computer-readable media (e.g., a random access memory (RAM) and/or read-only memory (ROM) of the railcar content analysis system 10) and that is executed by one or more processors of the railcar content analysis system 10 (such as, for example, analysis unit 16) to perform the corresponding functions described herein. Still additionally or alternatively, each of some or all of the components 12, 14, and 16 may at least partially comprise hardware and/or firmware. Further, one or more of the components 12, 14, and 16 may be combined into a single unit, or may be omitted.

In one embodiment, the railcar content analysis system 10 may receive and store LiDAR-based images of railcars. The images may be received and stored at image database server 12 from a LiDAR sensor 20 positioned within a rail yard. Image database server 12 may include any suitable type of persistent memory, and may comprise one or more data storage devices that have the appearance of a single, logical data storage device. Additionally or alternatively, the image database server 12 may be triggered to send one or more images to notification module 14 to accompany one or more notifications to send to worker computing devices 6. For example, the act of initially storing images of a railcar may trigger the image database server 12 to automatically send the railcar images to notification module 14, where the images are automatically paired with notifications. Additionally or alternatively, image database server 12 may be triggered to send one or more images to analysis unit 16 to be analyzed, where the one or more images and the analysis are subsequently sent to notification module 14 for inclusion in one or more notifications to send to worker computing devices 6.

In examples described herein, a railcar content analysis system 10 provides analysis information of railcars to a rail yard management team 8 so that rail yard workers on management team 8 can manage the allocation of the railcars in a rail yard. In certain embodiments, through the use of the railcar content analysis system 10, rail yard workers, via worker computing devices 6, can receive notifications from notification module 14 including images and analysis information of railcars. As a result of the content of the notifications, the rail yard workers can properly allocate the railcars that are the subject of the notifications within the rail yard.

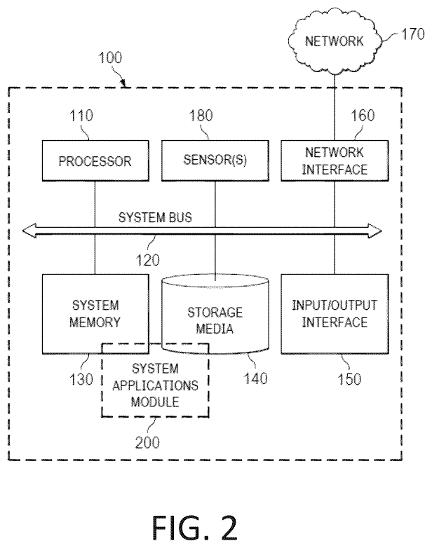

Referring now to FIG. 2, illustrated is a computing machine 100 and a system applications module 200, in accordance with example embodiments. The computing machine 100 can correspond to any of the various computers, mobile devices, laptop computers, Internet of Things (IoT), servers, embedded systems, or computing systems presented herein. The module 200 can comprise one or more hardware or software elements, e.g. other OS application and user and kernel space applications, designed to facilitate the computing machine 100 in performing the various methods and processing functions presented herein. The computing machine 100 can include various internal or attached components such as a processor 110, system bus 120, system memory 130, storage media 140, input/output interface 150, a network interface 160 for communicating with a network 170, e.g. cellular/GPS, Bluetooth, WIFI, or Devicenet, EtherCAT, Analog, RS485, etc., and one or more sensors 180.

The computing machines can be implemented as a conventional computer system, an embedded controller, a laptop, a server, a mobile device, a smartphone, a wearable computer, a customized machine, any other hardware platform, or any combination or multiplicity thereof. The computing machines can be a distributed system configured to function using multiple computing machines interconnected via a data network or bus system.

Processor 110 can be designed to execute code instructions in order to perform the operations and functionality described herein, manage request flow and address mappings, and to perform calculations and generate commands. Processor 110 can be configured to monitor and control the operation of the components in the computing machines. Processor 110 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. Processor 110 can be a single processing unit, multiple processing units, a single processing core, multiple processing cores, special purpose processing cores, co-processors, or any combination thereof. According to certain embodiments, processor 110 along with other components of computing machine 100 can be a software based or hardware based virtualized computing machine executing within one or more other computing machines.

The system memory 130 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 130 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 130. The system memory 130 can be implemented using a single memory module or multiple memory modules. While the system memory 130 is depicted as being part of the computing machine, one skilled in the art will recognize that the system memory 130 can be separate from the computing machine 100 without departing from the scope of the subject technology. It should also be appreciated that the system memory 130 can include, or operate in conjunction with, a non-volatile storage device such as the storage media 140.

The storage media 140 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 140 can store one or more operating systems, application programs and program modules, data, or any other information. The storage media 140 can be part of, or connected to, the computing machine 100. The storage media 140 can also be part of one or more other computing machines that are in communication with the computing machine such as servers, database servers, cloud storage, network attached storage, and so forth.

The applications module 200 and other OS application modules can comprise one or more hardware or software elements configured to facilitate the computing machine with performing the various methods and processing functions presented herein. The applications module 200 and other OS application modules can include one or more algorithms or sequences of instructions stored as software or firmware in association with the system memory 130, the storage media 140 or both. The storage media 140 can therefore represent examples of machine or computer readable media on which instructions or code can be stored for execution by the processor 110. Machine or computer readable media can generally refer to any medium or media used to provide instructions to the processor 110. Such machine or computer readable media associated with the applications module 200 and other OS application modules can comprise a computer software product. It should be appreciated that a computer software product comprising the applications module 200 and other OS application modules can also be associated with one or more processes or methods for delivering the applications module 200 and other OS application modules to the computing machine via a network, any signal-bearing medium, or any other communication or delivery technology. The applications module 200 and other OS application modules can also comprise hardware circuits or information for configuring hardware circuits such as microcode or configuration information for an FPGA or other PLD. In one exemplary embodiment, applications module 200 and other OS application modules can include algorithms capable of performing the functional operations described by the flow charts (modes of operation) computer systems presented herein.

The input/output (“I/O”) interface 150 can be configured to couple to one or more external devices, to receive data from the one or more external devices, and to send data to the one or more external devices. Such external devices along with the various internal devices can also be known as peripheral devices. The I/O interface 150 can include both electrical and physical connections for coupling the various peripheral devices to the computing machine or the processor 110. The I/O interface 150 can be configured to communicate data, addresses, and control signals between the peripheral devices, the computing machine 100, or the processor 110. The I/O interface 150 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 150 can be configured to implement only one interface or bus technology. Alternatively, the I/O interface 150 can be configured to implement multiple interfaces or bus technologies. The I/O interface 150 can be configured as part of, all of, or to operate in conjunction with, the system bus 120. The I/O interface 150 can include one or more buffers for buffering transmissions between one or more external devices, internal devices, the computing machine 100, or the processor 110.

The I/O interface 150 can couple the computing machine 100 to various input devices including mice, touch-screens, scanners, electronic digitizers, sensors, receivers, touchpads, trackballs, cameras, microphones, keyboards, any other pointing devices, or any combinations thereof. The I/O interface 150 can couple the computing machine 100 to various output devices including video displays, speakers, printers, projectors, tactile feedback devices, automation control, robotic components, actuators, motors, fans, solenoids, valves, pumps, transmitters, signal emitters, lights, and so forth.

The computing machine 100 can operate in a networked environment using logical connections through the NIC 160 to one or more other systems or computing machines across a network 170. The network 170 can include wide area networks (WAN), local area networks (LAN), intranets, the Internet, wireless access networks, wired networks, mobile networks, telephone networks, optical networks, or combinations thereof. The network 170 can be packet switched, circuit switched, of any topology, and can use any communication protocol. Communication links within the network 170 can involve various digital or an analog communication media such as fiber optic cables, free-space optics, waveguides, electrical conductors, wireless links, antennas, radio-frequency communications, and so forth.

The one or more sensors 180 can be a position sensor. The position sensor can be a capacitive, optical, strain gauge, or magnetic sensor. More specifically, the position sensor can be an optical sensor such as, for example, a LiDAR sensor. The sensors 180 can be traditional sensors or semiconductor based sensors.

The processor 110 can be connected to the other elements of the computing machine 100 or the various peripherals discussed herein through the system bus 120. It should be appreciated that the system bus 120 can be within the processor 110, outside the processor 110, or both. According to some embodiments, any of the processors 110, the other elements of the computing machine 100, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

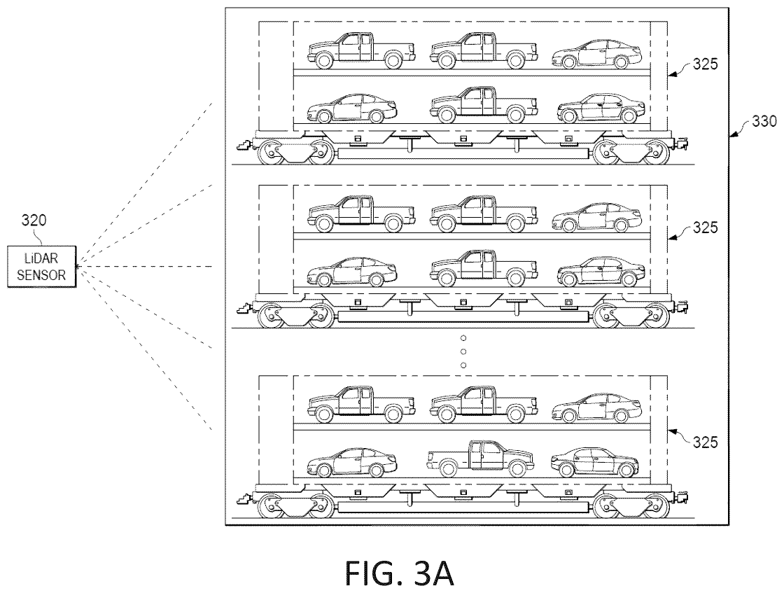

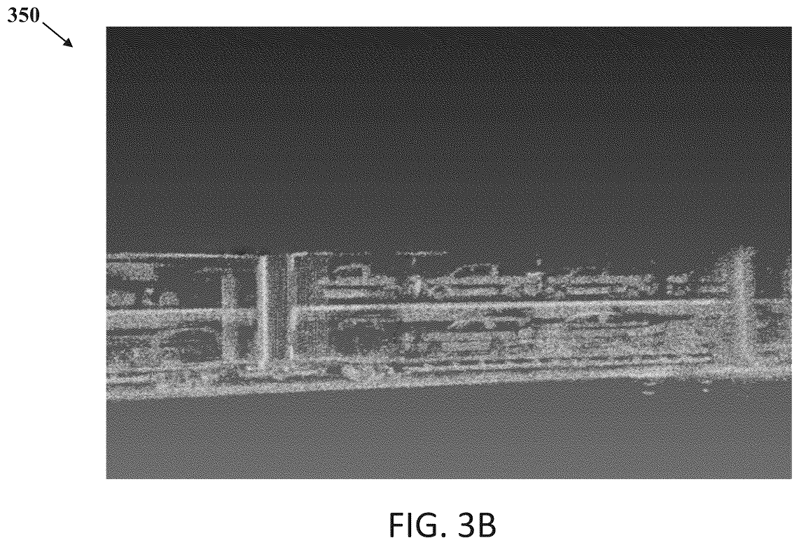

FIG. 3A is an illustration of a LiDAR sensor 320 capturing images of railcars 325 in a rail yard, in accordance with certain embodiments of the present disclosure. As shown, LiDAR sensor 320 is positioned in the vicinity of a plurality of railcars 325. In this embodiment, the railcars 325 (alternatively referred to as autoracks 325) located at an autorack facility 330, where each autorack 325 carries at least one automobile. It is noted that the automobiles are loaded and unloaded at autorack facility 330, which may alternatively be referred to as an “Auto Ramps” facility. These facilities, or yards, include large parking areas for the storage of automobiles as well as special equipment to load and unload the vehicles. As an example, autorack facility 330 may include ramps that are configured to attach to autoracks 325 that provide a means for the automobiles to be loaded or unloaded from the autoracks 325. As shown in FIG. 3B, a LiDAR image 350 of multiple railcars (autoracks) are shown. In order to capture image 350, a LiDAR sensor (such as, for example, LiDAR sensor 320) positioned adjacent the autoracks emits laser pulses in the direction of the autoracks. The pulses reflect off of portions of the autoracks and their contents, where the reflections are captured by LiDAR sensor 320 in order to form image 350. It is noted that autoracks may generally contain hundreds of small openings in their structure, allowing for the laser pulses of the LiDAR sensor 320 to penetrate the autoracks and therefore provide imagery of the contents of the autoracks (as shown, automobiles). As further shown, one of the autoracks 325 in FIG. 3A (the bottom section of the bottom autorack 325) is carrying two automobiles positioned facing an opposite direction of the automobiles positioned in the adjacent autoracks 325 while one of the autoracks in image 350 of FIG. 3B (the bottom section of the leftmost autorack) is carrying one automobile positioned facing an opposite direction of the automobiles positioned in the adjacent autoracks. This may be problematic for purposes of unloading the automobiles from the autoracks. As a result of images taken by the LiDAR sensor 320, autorack contents can be analyzed without having to physically check each autorack, which leads to more efficient management of the autoracks. For example, autoracks may be grouped (and subsequently unloaded) at a location within an autorack facility 330 based on the direction that the automobiles face within each of the autoracks 325.

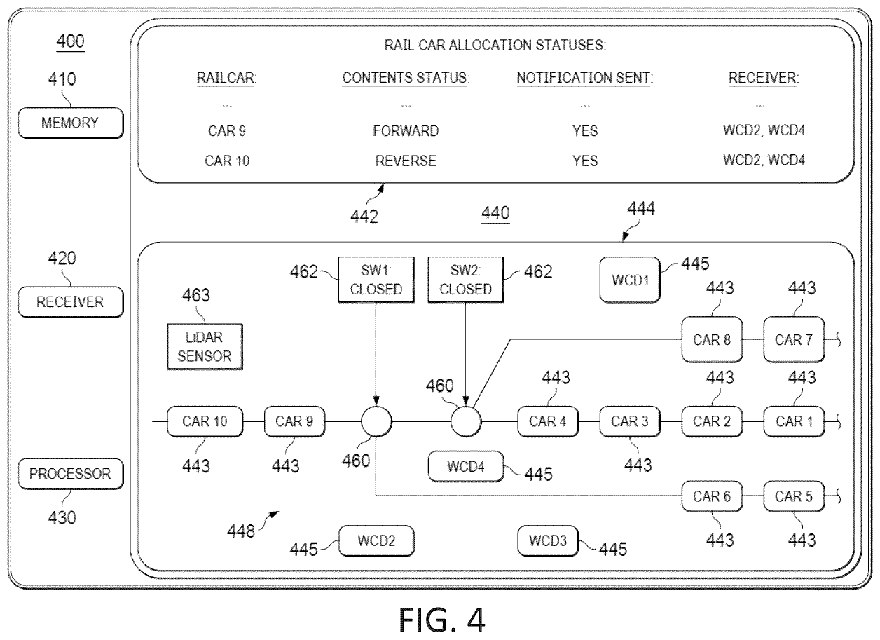

FIG. 4 is a diagrammatic view of an operator mobile computing device 400 for managing information relative to an autorack facility in accordance with certain embodiments of the present disclosure. It is noted that an operator may be a worker of a worker computing device 6 of FIG. 1, but in a managerial role overseeing at least an autorack facility of a rail yard. It is further noted that in certain embodiments, operator mobile computing device 400 may embody at least a portion of railcar content analysis system 10. Mobile computing device 400 may include a memory 410, a receiver 420, a processor 430, and a user interface 440. User interface 440 may present one or more graphics 442, 444, each including information relative to the autorack facility and/or the entire train yard. Graphic 442 is configured as a dashboard, where status and notification information are presented to the operator of mobile computing device 400. As shown, a first column in graphic 442 presents a list of railcars carrying automobiles within an autorack facility in a rail yard, denoted as: CAR 9 (“Railcar” 9) and CAR 10 (“Railcar” 10). In a second column, a status of the positioning of the automobiles in each railcar is presented, where CAR 9 is presented with a “Forward” status (implying that the automobiles are facing forward and that no additional steps need to be taken regarding CAR 9 other than grouping CAR 9 with other railcars that also include automobiles facing forward) and CAR 10 is presented with a “Reverse” status (implying that the automobiles are facing in reverse and that additional steps need to be taken regarding CAR 10, including grouping CAR 10 with other railcars that also include automobiles facing in reverse). For example, these “reversed” railcars, once grouped together, may be spaced and unloaded similarly to the non-reversed railcars. As another example, lifting devices (such as cranes, for example), may be utilized to lift and turn the “reversed” railcars around so that the railcars may be unloaded similarly to the non-reversed railcars using at least the ramps as described above.

Further in regard to FIG. 4, depending on the status of a railcar, a notification may be sent to one or more worker mobile computing devices associated with workers who work in the rail yard (such as, for example, workers associated with worker computing devices 6 of FIG. 1). A third column in graphic 442 presents a list of statuses of notifications sent to one or more worker mobile computing devices, where statuses are presented as either “yes” or “no”. A fourth column in graphic 442 presents a “receiver” of notifications sent to the one or more (as shown, two) worker mobile computing devices. Each receiver/worker mobile computing device may be abbreviated as “WCD1” (aka, worker computing device 1), “WCD2”, “WCD3”, “WCD4”, etc. If a notification was not sent in relation to a status of a railcar, the receiver column will read “N/A”. As shown, notifications were sent to WCD2 and WCD4, which, as seen in map 448, are located closest to the switches 460 that may need adjustment in order to properly allocate CAR 9 and CAR 10 to appropriate locations.

Graphic 444, as shown, is configured as a map 448, where map 448 includes a representation of a plurality of track sections forming at least a portion of track paths relative to an autorack facility, as well as a number of train routing devices 460 (switches, denoted as “SW1” and “SW2”) shown spatially depicted along track sections and including status indicators 462. As depicted, train routing devices 460 are used to sort railcars 443 based on the direction that the automobiles they are carrying are facing. In order to know whether to open or close switches 460, a LiDAR sensor 463 is positioned adjacent incoming railcars 443 to create images (such as, for example, LiDAR image 350) of the railcars 443 that may be analyzed by analysis unit 16 via image database server 12 (FIG. 1). Subsequently, the image analysis (and/or the images) may be sent to notification module 14 for inclusion in one or more notifications to send to worker mobile computing devices 445.

As further depicted, “live” icons depicting railcars 443 (as shown, “CAR 1”, “CAR 2”, “CAR 3”, “CAR 4”, “CAR 5”, “CAR 6”, “CAR 7”, “CAR 8”, “CAR 9”, and “CAR 10”) are presented in locations on the tracks, while live icons depicting worker mobile computing devices 445 (as shown, “WCD1”, “WCD2”, “WCD3”, and “WCD4”) are shown dispersed throughout the autorack facility. The live icons may depict real-time locations of railcars 443 and worker mobile computing devices 445 in the autorack facility via translation of GPS signals from the trains and worker mobile electronic devices into the live icons by a processor of operator mobile computing device 400. As shown, railcars 443 (CAR 1-CAR 8) have already been sorted to appropriate locations (as depicted, two different locations for railcars 443 having “Forward” facing automobiles and automobiles in “Reverse” positioning) based on the image analysis. CAR 1, CAR 2, CAR 3, and CAR 4 443 have been classified and sorted as “Forward”, implying that their contents (automobiles) are facing forward; CAR 7 443 and CAR 8 443 have been similarly classified. CAR 5 443 and CAR 6 443 have been classified and sorted as “Reverse”, implying that their contents (automobiles) are facing in reverse. As further shown, railcars 443 (CAR 9 and CAR 10) have been analyzed but not sorted. Based on the analysis of analysis unit 16, CAR 9 443 has been classified as “Forward”, implying that CAR 9 443 needs to be put on the same track as CAR 7 443 and CAR 8 443. In regard to CAR 10 443, CAR 10 443 has been classified as “Reverse”, implying that CAR 10 443 needs to be put on the same track as CAR 5 443 and CAR 6 443. As shown on map 448, SW1 460 and SW2 are both positioned in a “closed” position. In order to move CAR 9 443 to the appropriate location specified above, worker associated with WCD2 445 should alter SW1 460 so that it is in an “open” position so that CAR 9 443 follows the appropriate track to the final location. In regard to CAR 10 443, once CAR 9 443 is properly allocated, worker associated with WCD2 445 should alter SW1 460 so that it is in a “closed” position and worker associated with WCD4 445 should alter SW2 460 so that it is in an “open” position so that CAR 10 443 follows the appropriate track to the final location. It is noted that the railcars 443 may be moved to a final location via a locomotive.

It is noted that the sorting of railcars 443 further comprises adjusting one or more train routing devices 460 associated with a track section positioned between a current location of each of the plurality of railcars 443 and at least one of the at least two different locations.

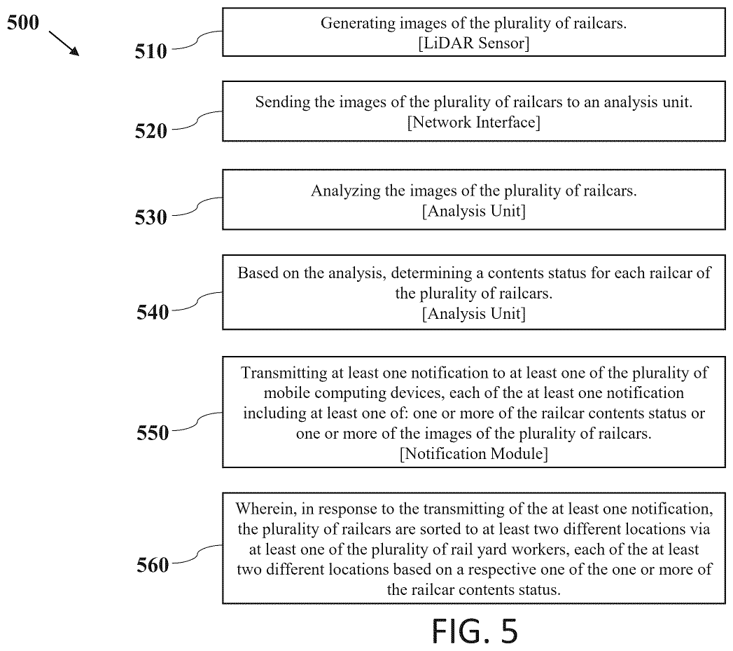

FIG. 5 is an illustration of an exemplary computer-implemented method 500 for allocating a plurality of railcars in a rail yard based upon analysis of contents of the plurality of railcars, in accordance with certain embodiments of the present disclosure. In an embodiment, at least a portion of method 500 may be performed by railcar content analysis system 10 of FIG. 1 and/or computing machine 100 of FIG. 2. For example, method 500 may be performed by executing particular computer-executable instructions stored on railcar content analysis system 10. Additionally, method 500 may operate in conjunction with environment 2, railcar content analysis system 10 of FIG. 1, and/or computing machine 100 of FIG. 2, and/or any one or more portions of any one or more of the other systems or methods described herein. It is further noted that the description of method 500 may include elements of any of environment 2, railcar content analysis system 10 of FIG. 1, and/or computing machine 100 of FIG. 2, and/or any one or more portions of any one or more of the other systems or methods described herein.

Method 500 may be carried out by communicatively coupling a system (for example, railcar content analysis system 10 of FIG. 1, computing machine 100 of FIG. 2, or another suitable system) to respective computing devices 6 of a plurality of workers of a rail yard; particularly configuring one or more tangible, non-transitory memories of the system by storing thereon particular computer-executable instructions for allocating a plurality of railcars 325 in a rail yard based upon analysis of contents of the plurality of railcars 325; and/or executing, by one or more processors of the system, the particular computer-executable instructions.

In an embodiment, execution of the particular computer-executable instructions (as mentioned above) may cause the system to perform: generating, via a LiDAR sensor 320, images 350 of the plurality of railcars 325 (block 510); sending, via a network interface 160, the images 350 of the plurality of railcars 325 to an analysis unit 16 (block 520); analyzing, via the analysis unit 16, the images 350 of the plurality of railcars 325 (block 530); based on the analysis, determining, via the analysis unit 16, a contents status for each railcar 325 of the plurality of railcars 325 (block 540); and transmitting, via a notification module 14, at least one notification to at least one of the plurality of mobile computing devices 6, each of the at least one notification including at least one of: one or more of the railcar contents status or one or more of the images 350 of the plurality of railcars 325 (block 550); where, in response to the transmitting of the at least one notification, the plurality of railcars 325 are sorted to at least two different locations via at least one of the plurality of rail yard workers and where each of the at least two different locations are based on a respective one of the one or more of the railcar contents status (block 560).

In an embodiment, each of the plurality of railcars 325 comprises an autorack including at least one automobile.

In an embodiment, each of the at least two different locations are located within an autorack facility (such as, for example autorack facility 330).

In an embodiment, each of the one or more railcar contents status is based on a positioning of the at least one automobile in each of the plurality of autoracks 325.

In an embodiment, the sorting further comprises adjusting one or more train routing devices 460 associated with a track section positioned between a current location of each of the plurality of railcars 443 and at least one of the at least two different locations.

For the purposes of this disclosure, the terms “worker mobile computing device” and “worker computing device” may be synonymous.

For the purposes of this disclosure, an autorack facility may be defined as a portion of a rail yard.

In embodiments, railcar contents may be automobiles. In additional embodiments, railcar contents may be any goods/products besides automobiles that a railcar is capable of carrying/transporting.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:

Clause 1, a system for allocating a plurality of railcars in a rail yard based upon analysis of contents of the plurality of railcars, the system comprising: a network interface configured to communicatively couple the system to a plurality of mobile computing devices for a plurality of rail yard workers; a LiDAR sensor configured to create images of the plurality of railcars; an image database configured to store the images of the plurality of railcars; an analysis unit configured to analyze the images of the plurality of railcars; a notification module configured to send at least one of: the images of the plurality of railcars or the analysis of the images of the plurality of railcars to at least one of the plurality of mobile computing devices; one or more tangible, non-transitory memories storing computer-executable instructions that, when executed by one or more processors of the system, cause the system to: generate the images of the plurality of railcars; send the images of the plurality of railcars to the analysis unit; analyze the images of the plurality of railcars; based on the analysis, determine a contents status for each railcar of the plurality of railcars; and transmit at least one notification to at least one of the plurality of mobile computing devices, each of the at least one notification including at least one of: one or more of the railcar contents status or one or more of the images of the plurality of railcars; wherein, in response to the transmitting of the at least one notification, the plurality of railcars are sorted to at least two different locations via at least one of the plurality of rail yard workers, each of the at least two different locations based on a respective one of the one or more of the railcar contents status.

Clause 2, the system of Clause 1, wherein each of the plurality of railcars comprises an autorack including at least one automobile.

Clause 3, the system of Clause 2, wherein each of the at least two different locations are located within an autorack facility.

Clause 4, the system of Clause 2, wherein each of the one or more railcar contents status is based on a positioning of the at least one automobile in each of the plurality of railcars.

Clause 5, the system of Clause 1, wherein the sorting further comprises adjusting one or more train routing devices associated with a track section positioned between a current location of each of the plurality of railcars and at least one of the at least two different locations.

Clause 6, a computer-implemented method for allocating a plurality of railcars in a rail yard based upon analysis of contents of the plurality of railcars via an electronic or communications network, the method comprising: generating, via a LiDAR sensor, images of the plurality of railcars; sending, via a network interface, the images of the plurality of railcars to an analysis unit; analyzing, via the analysis unit, the images of the plurality of railcars; based on the analysis, determining, via the analysis unit, a contents status for each railcar of the plurality of railcars; and transmitting, via a notification module, at least one notification to at least one of the plurality of mobile computing devices, each of the at least one notification including at least one of: one or more of the railcar contents status or one or more of the images of the plurality of railcars; wherein, in response to the transmitting of the at least one notification, the plurality of railcars are sorted to at least two different locations via at least one of the plurality of rail yard workers, each of the at least two different locations based on a respective one of the one or more of the railcar contents status.

Clause 7, the method of Clause 6, wherein each of the plurality of railcars comprises an autorack including at least one automobile.

Clause 8, the method of Clause 7, wherein each of the at least two different locations are located within an autorack facility.

Clause 9, the method of Clause 7, wherein each of the one or more railcar contents status is based on a positioning of the at least one automobile in each of the plurality of railcars.

Clause 10, the method of Clause 1, wherein the sorting further comprises adjusting one or more train routing devices associated with a track section positioned between a current location of each of the plurality of railcars and at least one of the at least two different locations.

Clause 11, a non-transitory computer-readable storage medium storing one or more programs configured to be executed by one or more processors of an electronic device, the one or more programs including instructions for: generating, via a LiDAR sensor, images of the plurality of railcars; sending, via a network interface, the images of the plurality of railcars to an analysis unit; analyzing, via the analysis unit, the images of the plurality of railcars; based on the analysis, determining, via the analysis unit, a contents status for each railcar of the plurality of railcars; and transmitting, via a notification module, at least one notification to at least one of the plurality of mobile computing devices, each of the at least one notification including at least one of: one or more of the railcar contents status or one or more of the images of the plurality of railcars; wherein, in response to the transmitting of the at least one notification, the plurality of railcars are sorted to at least two different locations via at least one of the plurality of rail yard workers, each of the at least two different locations based on a respective one of the one or more of the railcar contents status.

Clause 12, the non-transitory computer-readable storage medium of Clause 11, wherein each of the plurality of railcars comprises an autorack including at least one automobile.

Clause 13, the non-transitory computer-readable storage medium of Clause 12, wherein each of the at least two different locations are located within an autorack facility.

Clause 14, the non-transitory computer-readable storage medium of Clause 12, wherein each of the one or more railcar contents status is based on a positioning of the at least one automobile in each of the plurality of railcars.

Clause 15, the non-transitory computer-readable storage medium of Clause 11, wherein the sorting further comprises adjusting one or more train routing devices associated with a track section positioned between a current location of each of the plurality of railcars and at least one of the at least two different locations.

What is claimed is:

1. A system for allocating a plurality of railcars in a rail yard based upon analysis of contents of the plurality of railcars, the system comprising:
a network interface configured to communicatively couple the system to a plurality of mobile computing devices for a plurality of rail yard workers;
a LiDAR sensor configured to create images of the plurality of railcars;
an image database configured to store the images of the plurality of railcars;
an analysis unit configured to analyze the images of the plurality of railcars;
a notification module configured to send at least one of: the images of the plurality of railcars or the analysis of the images of the plurality of railcars to at least one of the plurality of mobile computing devices;
one or more tangible, non-transitory memories storing computer-executable instructions that, when executed by one or more processors of the system, cause the system to:
generate the images of the plurality of railcars;
send the images of the plurality of railcars to the analysis unit;
analyze the images of the plurality of railcars;
based on the analysis, determine a contents status for each railcar of the plurality of railcars; and
transmit at least one notification to at least one of the plurality of mobile computing devices, each of the at least one notification including at least one of: one or more of the railcar contents status or one or more of the images of the plurality of railcars;
wherein, in response to the transmitting of the at least one notification, the plurality of railcars are sorted to at least two different locations via at least one of the plurality of rail yard workers, each of the at least two different locations based on a respective one of the one or more of the railcar contents status.

2. The system of claim 1, wherein each of the plurality of railcars comprises an autorack including at least one automobile.

3. The system of claim 2, wherein each of the at least two different locations are located within an autorack facility.

4. The system of claim 2, wherein each of the one or more railcar contents status is based on a positioning of the at least one automobile in each of the plurality of railcars.

5. The system of claim 1, wherein the sorting further comprises adjusting one or more train routing devices associated with a track section positioned between a current location of each of the plurality of railcars and at least one of the at least two different locations.

6. A computer-implemented method for allocating a plurality of railcars in a rail yard based upon analysis of contents of the plurality of railcars via an electronic or communications network, the method comprising:
generating, via a LiDAR sensor, images of the plurality of railcars;
sending, via a network interface, the images of the plurality of railcars to an analysis unit;
analyzing, via the analysis unit, the images of the plurality of railcars;
based on the analysis, determining, via the analysis unit, a contents status for each railcar of the plurality of railcars; and
transmitting, via a notification module, at least one notification to at least one of the plurality of mobile computing devices, each of the at least one notification including at least one of: one or more of the railcar contents status or one or more of the images of the plurality of railcars;
wherein, in response to the transmitting of the at least one notification, the plurality of railcars are sorted to at least two different locations via at least one of the plurality of rail yard workers, each of the at least two different locations based on a respective one of the one or more of the railcar contents status.

7. The method of claim 6, wherein each of the plurality of railcars comprises an autorack including at least one automobile.

8. The method of claim 7, wherein each of the at least two different locations are located within an autorack facility.

9. The method of claim 7, wherein each of the one or more railcar contents status is based on a positioning of the at least one automobile in each of the plurality of railcars.

10. The method of claim 1, wherein the sorting further comprises adjusting one or more train routing devices associated with a track section positioned between a current location of each of the plurality of railcars and at least one of the at least two different locations.

11. A non-transitory computer-readable storage medium storing one or more programs configured to be executed by one or more processors of an electronic device, the one or more programs including instructions for:
generating, via a LiDAR sensor, images of the plurality of railcars;
sending, via a network interface, the images of the plurality of railcars to an analysis unit;
analyzing, via the analysis unit, the images of the plurality of railcars;
based on the analysis, determining, via the analysis unit, a contents status for each railcar of the plurality of railcars; and
transmitting, via a notification module, at least one notification to at least one of the plurality of mobile computing devices, each of the at least one notification including at least one of: one or more of the railcar contents status or one or more of the images of the plurality of railcars;
wherein, in response to the transmitting of the at least one notification, the plurality of railcars are sorted to at least two different locations via at least one of the plurality of rail yard workers, each of the at least two different locations based on a respective one of the one or more of the railcar contents status.

12. The non-transitory computer-readable storage medium of claim 11, wherein each of the plurality of railcars comprises an autorack including at least one automobile.

13. The non-transitory computer-readable storage medium of claim 12, wherein each of the at least two different locations are located within an autorack facility.

14. The non-transitory computer-readable storage medium of claim 12, wherein each of the one or more railcar contents status is based on a positioning of the at least one automobile in each of the plurality of railcars.

15. The non-transitory computer-readable storage medium of claim 11, wherein the sorting further comprises adjusting one or more train routing devices associated with a track section positioned between a current location of each of the plurality of railcars and at least one of the at least two different locations.
